(19) United States
(12) Patent Application Publication
(10) Pub. No.: US 2016/0283921 A1
(43) Pub. Date: Sep. 29, 2016

(54) Data Structures for Plan of Care Related Data

(71) Applicant: IMS Health Incorporated, Danbury, CT (US)

(72) Inventors: Parvathy Ramanathan, Bellevue, WA (US); Lingyun Su, Philadelphia, PA (US); John Daly, Mendham, NJ (US)

(21) Appl. No.: 14/669,165

(22) Filed: Mar. 26, 2015

(51) Int. Cl. G06Q 20/10; G06Q 50/22; G06F 19/00

(52) U.S. Cl. CPC G06Q 20/10; G06F 19/322; G06Q 50/22

(57) ABSTRACT

A computer-implemented method includes receiving a treatment record descriptive of a pharmacy purchase transaction that includes a prescriber identification code and a pharmaceutical compound related to treatment for an individual disease state, and associating the received treatment record with a code indicative of a provider network. The treatment record is related to a time-based treatment record descriptive of a projected disease state for a specified treatment area and a treatment model is developed based on relating the received treatment record to the time-based treatment record. The treatment model indicates projected occurrences of the disease state over a specified time frame, the projected occurrences including a first code indicative of a prescribing authority, the treatment model also including an association label that identifies a linkage between treatment records with a threshold degree of similarity. Referencing a provider network behavioral model for the provider network based on the code indicative of the provider network, and using the code indicative of the provider network to update the provider network behavioral model. Comparing the updated provider network behavioral model to the treatment model, and generating an instruction record for the specified treatment area, wherein generating the instruction record comprises generating an aggregated impact label indicative of addressable disease states for a specified treatment area.

### BACKGROUND

Provider Networks are a relatively new stakeholder in the life sciences market, and over the years provider networks have proven to be increasingly dominant.

### SUMMARY

In one aspect, a computer-implemented method includes receiving a treatment record descriptive of a pharmacy purchase transaction that includes a prescriber identification code and a pharmaceutical compound related to treatment for an individual disease state, and associating the received treatment record with a code indicative of a provider network. The treatment record is related to a time-based treatment record descriptive of a projected disease state for a specified treatment area and a treatment model is developed based on relating the received treatment record to the time-based treatment record. The treatment model indicates projected occurrences of the disease state over a specified time frame, the projected occurrences including a first code indicative of a prescribing authority, the treatment model also including an association label that identifies a linkage between treatment records with a threshold degree of similarity. Referencing a provider network behavioral model for the provider network based on the code indicative of the provider network, and using the code indicative of the provider network to update the provider network behavioral model. Comparing the updated provider network behavioral model to the treatment model, and generating an instruction record for the specified treatment area, wherein generating the instruction record comprises generating an aggregated impact label indicative of addressable disease states for a specified treatment area.

In another aspect, generating an instruction record for the specified treatment area based on comparing the provider network behavioral model to the treatment model includes generating an instruction record for the specified treatment area in the time required to establish a Transmission Control Protocol (TCP) connection.

In yet another aspect, developing a treatment model based on relating the received treatment record to the time-based treatment record includes developing a treatment model of local prescribers non-affiliated with a provider network. In another aspect, referencing a record descriptive of a provider network includes referencing a record that includes a provider network impact score. In yet another aspect, the provider network impact score assesses the impact of the provider network on the prescribing behavior within the specified treatment area.

In another aspect, the provider network impact score assess the impact of the provider network on the prescribing behavior of physicians on a national level for the particular disease state. In another aspect, the provider network impact score evaluates the prescribing behavior of physicians within one or more classes of drugs used to treat the disease state. In yet another aspect, referencing a time-based treatment model descriptive of a projected disease state for a specified treatment area includes associating qualitative and quantitative pharmaceutical data to model an instruction model. In another aspect, referencing a time-based treatment model descriptive of a projected disease state for a specified treatment area includes referencing a time-based mathematical model descriptive of a projected disease state for a particular a state, county, or zip code.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example of an analytical infrastructure system implemented in a computing system 100.

FIG. 2 illustrates the various stakeholders in the life sciences market.

FIG. 3 illustrates an example of the role of various stakeholders that are involved in determining a unified commercial strategy.

FIG. 4 illustrates a comparison between two market assessment methodologies.

FIG. 5 illustrates the impact of integrated delivery networks (IDN) across local geographies.

FIG. 6 illustrates the benefits of implementing analytics using the analytical infrastructure.

FIG. 7 is a flow chart of a process by which an analytical infrastructure identifies records that deviate from a typical local treatment plan.

FIG. 8 illustrates the quantitative and qualitative analysis used by the analytical infrastructure.

FIG. 9 illustrates an example strategy for determining a favorable IDN versus an unfavorable IDN by the analytical infrastructure.

FIG. 10 is a flow chart of a process by which an analytical infrastructure generates an instruction record.

### DETAILED DESCRIPTION

Processing the large volume of data involved with health care transactions can be extremely cumbersome. First, identifying data is generally anonymized in order to comply with applicable privacy laws. Second, the sheer number of records means that conducting even the simplest of queries and identifying even the simplest of associations can impose a tremendous computational burdens. Finally, deriving semantics from a particular transaction and relating it to content and issues appearing in other records is even more burdensome. These factors mean that developing health care analytics represents a tremendous computational challenge.

For example, a health care administrator may be trying to identify safety trends that indicate whether affiliated physicians administering medical care (as reflected by health care claims and prescribing data) consistent with different treatment regimens, standards of care, trends, and/or guidance. Often times, identifying a single trend or deviation from a prescribed course of care amounts to finding the proverbial needle-in-the-haystack as disparate data sources are reconciled in order to conduct the required analytics, identify anomalies, and categorize associations between seemingly unrelated data points. These trends can be used to improve patient safety by identifying better treatment regimens for applicable communities (e.g., a particular facility, office, or physician) and situations (e.g., a specified diagnosis or fact pattern of an illness).

Identifying applicable associations may be even more complicated when accounting for the role of market pressures on health care decisions. For example, a similar diagnosis may be addressed in two completely different manners if a provider network or an insurer has introduced controls into a plan of care. The controls or even affiliations may not be coded in a health care transaction. Thus, the ability to understand all the applicable factors and improve patient safety may be at-risk if the role of the controls is not understood.

This disclosure generally describes computer-implemented methods, software, and systems for determining and measuring the impact of IDNs on a specific localized geographical area, and developing a go to market strategy for every prioritized Provider Network, based on a particular disease state a using an analytical infrastructure. The disclosure describes computer-implemented methods, software, and systems for accessing healthcare data for a particular geographical region, and processing large amounts of data to access IDN impact in a particular disease state, and further generating a pharma go to market strategy for the particular region. The methodology incorporates the complex impact of provider networks, such as IDNs, as well as other influencers like payers, patients, physicians and the products themselves into designing an appropriate go to market strategy approach including marketing strategy and sales strategy.

There have been several changes to the healthcare environment, and new stake holders have had an increasingly large effect on the market share. In particular, the increasing number of Integrated Delivery Networks has greatly impacted the selection of prescription drug choice by physicians. An IDN is a network of facilities and providers that work together to offer a continuum of care to a specific geographic area or market and is type of managed care organization. Health Maintenance Organization (HMO), Accountable Care Organizations (ACO), and Preferred Provider Organization (PPO) represent managed care organizations. For the purpose of this application, the term IDN may be used to describe HMO, ACO and/or PPO organizations. IDNs may have implemented treatment guidelines and protocols that must be upheld by physicians within the network and therefore, by the nature of the IDN structure, prescription choice is influenced by an IDN presence. IDNs often require evidence of drug therapeutic effectiveness and costly effectiveness is also very important to the successful performance of an IDN. IDNs may even restrict pharmaceutical companies' sale representatives from promoting products to members of the IDN. Additionally, IDNs are usually established and operated within specific geographic regions. These factors together make it difficult for pharmaceutical manufacturers to understand the impact of IDNs on a particular area, and develop performance models for regions influenced by IDNs.

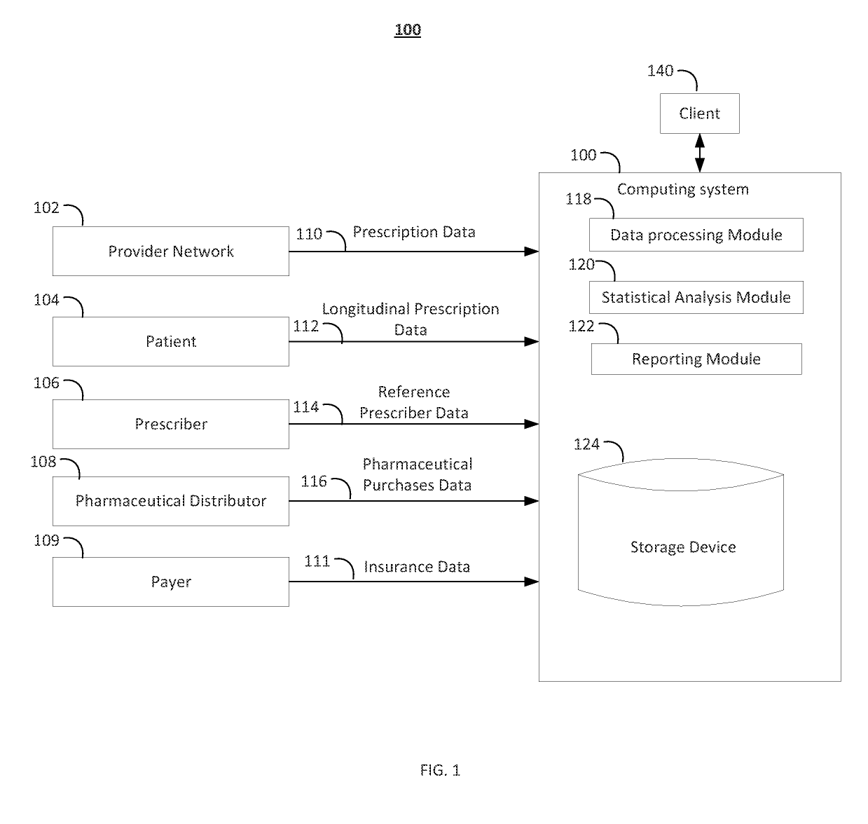

FIG. 1 illustrates an example analytical infrastructure system implemented in a computing system 100. The computing system may be implemented as a data processing apparatus that is capable of providing the functionality discussed herein, and may include any appropriate combination of processors, memory, and other hardware and software that can receive appropriate medical data and process the data as discussed below. At a high-level, the illustrated example computing system 100 receives various data from sources that are participants in the healthcare process. The sources may include provider network 102, patient system 104, prescriber system 106, pharmaceutical distributors 108, and payer system 109. The data may include physician prescription data 110, longitudinal patient data 112, reference prescriber data 114, pharmaceutical purchase data 116, and insurance data 111.

FIG. 1 illustrates the process by which an analytical infrastructure is able to integrate received data. The data from patient system 104 is not restricted to longitudinal patient data 112 but may include any data from a health care provider or the prescriber system 106. The data may include prescription information related to the patient, for example the recent prescriptions written to the patient and whether or not the prescription drug was covered by the patient's payer or insurance company. It is important to understand that the system may be configured to preserve patient privacy, and will not store nominative data in an aggregated database but only de-identified data. Nominative data for an individual can be compared to the relevant aggregated data, but this may be achieved by using aggregated values in the individual patient application, not by keeping nominative records for multiple patients in a single database. Also, the integration of data from sources other than the user and their medical professionals may be achieved on a de-identified basis except in the instance that the individual gives permission to use their identity information (name, location, gender and age) for the purpose of providing them with their information from another source, such as pharmaceutical purchase data 116 from pharmacies.

The physician prescription data 110 may include data regarding prescriptions prescribed by physicians within an IDN. The prescription data 110 may be received directly from one or more IDNs 102 and represent data reflecting all prescriptions for pharmaceutical products issued by physicians within the one or more IDNs 102, including information about the type of prescription used to obtain the product and the payment method used to purchase the product. As noted previously, this information may be sanitized and aggregated to protect patient privacy. The prescription data may include the total revenue spent on prescriptions based on the specific drug. In some implementations, the data may be based on the total revenue spent on a specific drug in a specific geographic location. The one or more IDNs may provide the retail prescription data 110 on a periodic basis (e.g., every week or month). Though FIG. 1 shows the prescription data 110 being provided directly from the one or more IDNs 102 to the computing system 100, the prescription data 110 may be collected by one or more other intermediate systems and then provided to the computing system 100. If intermediate systems are used, the aggregation and sanitization of the retail prescription data 110 may potentially be performed by the intermediate systems.

The longitudinal patient data 112 may include sanitized retail patient-level data for the one or more patient systems 104. For example, the longitudinal patient data 112 may include information about retail pharmacy-sourced prescription insurance claims, retail pharmaceutical scripts, and/or patient profile data. Longitudinal patient data 112 includes information about aspects of care for the one or more patient systems 104. Though FIG. 1 illustrates the longitudinal patient data 112 as being received by the computing system 100 directly from one or more patient systems 104, the longitudinal patient data 112 may be collected by one or more other systems and then provided to the computing system 100 in a manner analogous to the similar approach discussed for retail prescription data 110. Moreover, the longitudinal patient data 112 may not originate from the one or more patient systems 104, but may rather be provided by one or more prescribers/physicians with whom patient interacts, insurance companies to which a patient submits insurance claims, and/or retailers at which a patient purchases a pharmaceutical product. In some implementations the longitudinal patient data 112 may originate from one or more pharmaceutical companies.

The reference prescriber data 114 may include background information for one or more prescribers 106. For example, the reference prescriber data 114 may include a prescriber's demographic information, address, affiliations, authorization data (e.g., DEA, AOA, SLN, and/or NPI numbers), profession, and/or specialty. While most prescribers will be medical doctors, other healthcare professionals such as physician-assistants or nurse practitioners may also be prescriber systems 106. Though FIG. 1 illustrates the reference prescriber data 114 as being received by the computing system 100 directly from one or more prescriber systems 106, the reference prescriber data 114 may be collected by one or more other systems and then provided to the computing system 100 in a manner analogous to the similar approach discussed for retail prescription data 110. Moreover, the reference prescriber data 114 may not originate from the one or more prescriber systems 106, but rather be created and/or maintained by one or more other entities (e.g., government agencies or professional medical organizations) that track information about the prescribing behavior of prescribers 106.

The pharmaceutical purchase data 116 may include information about pharmaceutical purchases made from distributors 108 (e.g., pharmaceutical wholesalers or manufacturers). For example, the pharmaceutical purchase data 116 may include information about the outlet from which a pharmaceutical product is purchased, the type of pharmaceutical product purchased, the location of both the purchaser and seller of the pharmaceutical product, when the purchase was conducted, and/or the amount of a pharmaceutical product that was purchased. Though FIG. 1 illustrates the pharmaceutical purchase data 116 as being received by the computing system 100 directly from one or more distributors 108, the pharmaceutical purchase data 116 may be collected by one or more other systems and then provided to the computing system 100 in a manner analogous to the similar approach discussed for retail prescription data 110. Moreover, the pharmaceutical purchase data 116 may not originate from the one or more distributors 108, but rather be provided by the purchaser of the pharmaceutical product (e.g., a retail outlet).

The insurance data 111 may include information about insurance companies covering the cost of prescriptions. A payer may be the insurance company that covers a patient, or in the case where the patient does not have insurance, and is covered by Medicaid the payer may be the government. For example, the insurance data 111 may include information about how much of a prescription's cost was covered by the insurance company or by Medicaid. Though FIG. 1 illustrates the insurance data 111 as being received by the computing system 100 directly from one or more payer system 109, the insurance data 111 may be collected by one or more other systems and then provided to the computing system 100.

The various types of data just discussed, which may include prescription data 110, longitudinal prescription data 112, reference prescriber data 114, pharmaceutical purchases data 116, and insurance data 111, are received by computing system 100 in order to derive conclusions based on the data. As noted previously, by the time the data is received by computing system 100, it should have been sanitized so that the data does not include private or confidential information that computing system 100 should not able to access.

For illustrative purposes, computing system 100 will be described as including a data processing module 118, a statistical analysis module 120, a reporting module 122, and a storage device 124. However, the computing system 100 may be any computing platform capable of performing the described functions. The computing system 100 may include one or more servers that may include hardware, software, or a combination of both for performing the described functions. Moreover, the data processing module 118, the statistical analysis module 120, and the reporting module 122 may be implemented together or separately in hardware and/or software. Though the data processing module 118, the statistical analysis module 120, and the reporting module 122 will be described as each carrying out certain functionality, the described functionality of each of these modules may be performed by one or more other modules in conjunction with or in place of the described module.

The data processing module 118 receives and processes one or more of prescription data 110, longitudinal patient data 112, reference prescriber data 114, pharmaceutical purchase data 116, and insurance data 111. In processing the received data, the data processing module 118 may filter and/or mine the prescription data 110, longitudinal patient data 112, reference prescriber data 114, pharmaceutical purchase data 116, and insurance data for specific information. The data processing module 118 may filter and/or mine the received retail prescription data 110, longitudinal patient data 112, reference prescriber data 114, pharmaceutical purchase data 116, and insurance data 111 for specific pharmaceuticals. Thus, any received retail prescription data 110, longitudinal patient data 112, reference prescriber data 114, pharmaceutical purchase data 116, and insurance data 111 that regards pharmaceutical products that are not classified as being associated with a tracked compound or prescription may be disregarded. For example, the received data may be processed by data processing module 118 so as to track use of a specific antibiotic, or of antibiotics in general.

The system and method described involves the computer processing of large datasets. The computing systems at an analytical infrastructure are adapted to receive the datasets from one or more other computing systems. The computing systems at the analytical infrastructure are in electronic communication with one or more provider network systems. The analytical infrastructure receives large datasets including prescriptions prescribed by physicians within the provider networks. The prescription data received represents over 70% of the prescriptions written by physicians in a specific geographical area over the past 30 years. The datasets are updated weekly with the past weeks prescription data. The computing systems at the analytical infrastructure are in electronic communication with one or more patient systems. The computing systems at the analytical infrastructure receive large datasets that represents longitudinal patient level data. The longitudinal patient level data comprises sanitized patient level data that includes treatment details and prescription history of a large percentage of the patient population of the specific geographical area. The longitudinal patient level data represents patient data over the past 70 years. The computing systems at the analytical infrastructure are also in electronic communication with one or more prescriber systems. The datasets received from the prescriber systems includes prescriber details for over 90% of the prescriber population of the specific geographical region. The prescriber details includes the prescriber specialty, demographic information, and provider network or IDN affiliations. The computing systems at the analytical infrastructure receive pharmaceutical wholesale purchase data from one or more pharmaceutical distributor systems. The data includes close to 100% of the manufacturer purchase data for the specific geographic area for the past 50-60 years. The computing systems at the analytical infrastructure receive insurance claims data from one or more payer systems. The insurance claims data represents over 60% of the claims data for the specific geographical area for the past 40 years. The computing systems at the analytical infrastructure receive these datasets on a periodic basis from the one or more computer systems.

The computing systems are adapted to process the received datasets in a way that facilitates efficient operation for computational tasks. The processing operations of the computing systems are both time and energy efficient. The computing systems at the analytical infrastructure field and/or mine the received datasets for data that is associated with a therapeutic area of interest. The time for the processing of the datasets varies based on the volume of the data within each dataset. The computing systems may execute several cycles to process the large amounts of data. In most tested examples, the computing systems have had the ability to process the received datasets within ten days. The tested examples include identifying data associated with therapeutic areas such as diabetes, stroke, and high blood pressure.

The computing systems at the analytical infrastructure generate one or more references to the identified data within the received datasets. The generated references are specific to the therapeutic area of interest, and are stored at a computational database associated with the computing systems. Generating the references during the earlier stages of the processing allows the computing systems to identify records that deviate from a standard of care for a specific therapeutic area in a fraction of the time that would be required to isolate the deviate records from the received datasets. The computing systems may process the database that stores the generated references to identify references that deviate from a mathematical model that is representative of a standard of care for the therapeutic area. The computing systems process the generated references for a particular therapeutic, and identify records that deviate from the preferred prescribed course of care for the particular therapeutic area in the time required to maintain a query across a Transmission Control Protocol (TCP) connection.

Additionally, in some implementations, the reports generated may be either dynamic or static. The reporting module 122 may generate a report that includes data presented in one or more static formats (e.g., a chart, a graph, or a table) without providing any mechanism for altering the format and/or manipulating the data presented in the report. In such an implementation, the data presentation is generated and saved without incorporating functionality to update the data presentation. In some implementations, the reporting module 122 provides a static report in a PDF, spreadsheet, or XML format. Such a format generally provides an understanding of the reporting module 122 as textual data or a visualization, but other forms of presenting conclusions such as audio, video, or an animation are not excluded as potential results from reporting module 122. The reporting module 122 may provide a static report in a PowerPoint format.

Additionally or alternatively, the reporting module 122 may generate a report that includes controls allowing a user to alter and/or manipulate the report itself interactively. For example, the reporting system may provide a dynamic report in the form of an HTML document that itself includes controls for filtering, manipulating, and/or ordering the data displayed in the report. Moreover, a dynamic report may include the capability of switching between numerous visual representations of the information included in the dynamic report. In some implementations, a dynamic report may provide direct access as selected by a user to some or all of the patient data 126, prescriber data 128 and/or outlet data 130 prepared by the data processing module 118 and/or the statistical analysis module 120, as opposed to allowing access to only data and/or ratings included in the report itself.

One or more clients 140 may interface with the computing system 100 to request and receive reports created by the reporting system. In some implementations, the one or more clients 140 may include a web browser that provides Internet-based access to the computing system 100. Through the web browser, a user of a client 140 (e.g., a wholesaler, a retail outlet, or a prescriber) may request a static or dynamic report from the reporting system as discussed above.

There may be any number of clients 140 associated with, or external to, the example computing system 100. While the illustrated example computing system 100 is shown in communication with one client 140, alternative implementations of the example computing system 100 may communicate with any number of clients 140 suitable to the purposes of the example computing system 100. Further, the term “client” and “user” may be used interchangeably as appropriate without departing from the scope of this disclosure. Moreover, while the client 140 is described in terms of being used by a single user, this disclosure contemplates that many users may share the use of one computer, or that one user may use multiple computers.

The illustrated client 140 is intended to encompass computing devices such as a desktop computer, laptop/notebook computer, wireless data port, smartphone, personal digital assistant (PDA), tablet computing device, one or more processors within these devices, or any other suitable processing device. For example, the client 140 may include a computer that includes an input device, such as a keypad, touch screen, or other device that can accept user information, and an output device that conveys information associated with the operation of the computing system 100. The input device may be used by client 140 to provide instructions to computing system 100 that computing system 100 can execute to provide information requested by client 140 from the various data that computing system 100 receives. The analytical infrastructure may be supported on a webpage application that a client may use to view the data received by the computing system at the analytical infrastructure.

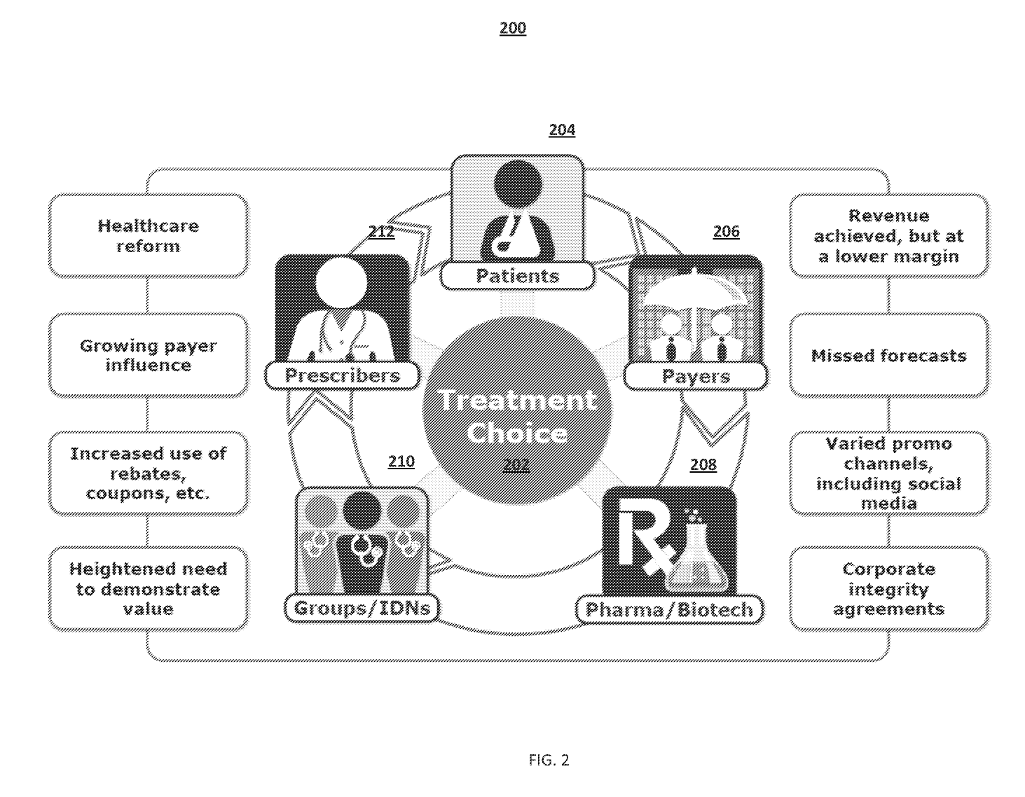

FIG. 2 illustrates the various stakeholders and other factors involved in affecting the treatment choice provided to a patient. Treatment choice 202 is the choice of prescription drug selected from a wide range of prescription drugs which may be used to treat a specific patient condition. Several various factors may affect the treatment choice of a patient as illustrated in FIG. 2. A patient is the person being treated for a specific condition and in need of a prescription drug. Patients have recently begun to increase their influence on the selection of prescription choice through self-advocacy and awareness of health conditions and available treatments. The increase in awareness by patients has occurred though electronic and social media, and also due to direct to consumer advertising from manufacturer. There has also been an increase in the number of patient advocacy organizations that help make patients aware of treatment choices and help to increase the influence of patients on treatment choice.

Payers 206 may also influence the treatment choice provided to a patient. A payer may be the insurance company of the patient, or in the case where the patient does not have insurance, the payer may be the government, since the prescription drugs may be provided to the patient by Medicaid. Insurance companies have been exerting pressure on pharmaceutical companies to reduce the cost of drugs through contracting and rebate programs. Payers, whether private or government have increasing influence on what physicians can and cannot prescribe to ensure that patients are able to afford treatment. Payers may affect the treatment choice by stipulating the drugs which will be covered by a particular insurance plan. The insurance company of the patient may stipulate a list of prescription medications that will be fully covered under the insurance plan. For example, the patient may select the treatment choice that includes the drug that is fully covered by the insurance instead of a treatment choice that includes a drug that may only by partially covered or not covered at all by the insurance plan. In some examples, patients covered by Medicaid are limited to the generic version of a pharmaceutical drug.

Health care reform may affect treatment choice. A change in the structure of healthcare may affect several actors in the determination of patient treatment choice. For example, more and more patients are being covered by ACOs. The introduction of the ACO concept changed the structure of health care and may have an impact on the determination of treatment choice of prescribers. For example, the Patient Protection and Affordable Care Act (PPACA) have expanded health care coverage to millions, who were previously uninsured. This reform of health care has increased the pressure on the health care industry to reduce the cost of health care. Growing payer influence 116 may also affect treatment choice selected by prescribers. Payers, such as insurance companies and in the case of patients on Medicaid, the government, specify a list of prescription drugs that will be covered by different heath care plans. The influence of the insurance companies may grow increasingly as insurance companies decrease the selection of prescription drugs that may be covered by ones' health care plan. Both government and private payers have an effect on treatment choice by pressuring physicians to prescribe affordable treatment choices.

A pharmaceutical company 208 may be the manufacturer and supplier of a pharmaceutical drug. Pharmaceutical companies may have a large impact on the selection of treatment choice. Pharmaceutical companies, in the past, have focused sales and marketing tactics solely on physicians and may even provide physicians with free samples to promote the use of a particular drug. Extensive marketing of a product by a pharmaceutical company to physicians may lead the physician to be persuaded by the sales tactics. Additionally, the introduction of a variety of new promotional channels into the marketing world has led to challenges within the marketing strategies of pharmaceutical companies. For example, the introduction of social media has allowed pharmaceutical companies with smaller marketing budgets to advertise pharmaceutical products for far less than other traditional marketing strategies.

Integrated Delivery Networks (IDNs) 210 may also affect the treatment choice for a patient. As mentioned above, an IDN is a network of facilities and providers that work together to offer a continuum of care to a specific geographic area or market. An IDN is a type of managed care organization and there are many different structures to an IDN. An IDN may be an organization that provides comprehensive health care to a voluntarily enrolled population at a predetermined price. In this case there is a direct contract between the physicians and the hospitals. The providers within the IDN offer discounted rates to members within the IDN. There are different types of IDNs and the structure of each different type of IDN is slightly different. For example in a staff model HMO, the physicians practice within HMO owned facilities and only see HMO enrollees, also the pharmacy services are through an in house facility. In this example, the HMO would have a large impact on the treatment choice selected by the physician since treatment choice would most likely be a product provided by the internal pharmacy services. In the United States, the government has many state laws that are meant to promote the development of IDNs to ensure the quality of care delivered to patients. This promotion of the development of IDNs has led to an increase in the number of IDNs across the nation exceeds 1200. IDNS have implemented strict treatment protocols that set strict guidelines to the physicians within an IDN on which drugs and treatments are preferred for which conditions. The IDNs may also require evidence of the effectiveness of a specific drug and the overall cost effectiveness before the drug may be approved to be prescribed to patients within the IDN. IDNs are generally established and operated within specific geographic regions.

Prescribers 212 are generally the physicians that prescribe pharmaceutical drugs to a patient. Prescribers may be influenced by all the other stakeholders, such as, patients, payers, IDNs, and pharmaceutical companies, when determining a treatment choice. As indicated above, pharmaceutical companies target physicians with their marketing and sales tactics for selling products. The pharmaceutical company may even provide free samples to physicians. The pharmaceutical company may require the prescriber tracks the number of distributed free samples and the number of patients that use the prescribed drug after receiving a free sample. Tracking free samples may include, the prescriber providing the patient with a voucher card that the patient may use to register online to receive the free sample from a pharmacy. In some cases, IDNs uphold strict restrictions that restrict pharmaceutical companies from even providing free samples to physicians within an IDN. In some cases, IDNs may also restrict or outright ban the entrance of pharmaceutical representatives to their facilities.

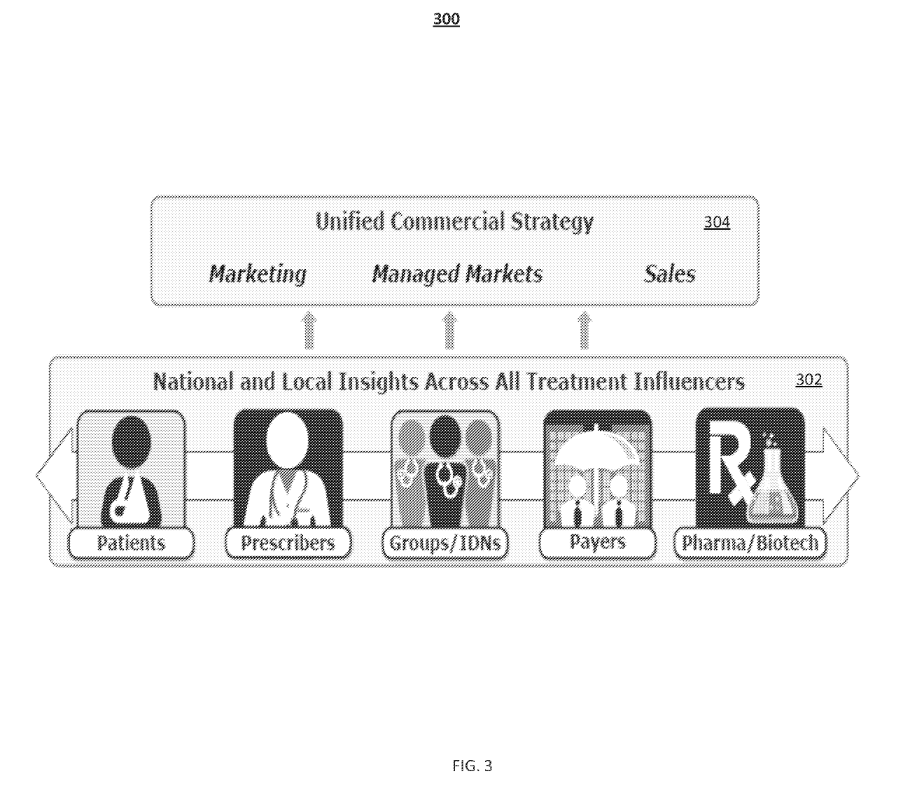

FIG. 3 illustrates an example 300 for determining a unified commercial strategy 304, for a pharmaceutical company by the analytical infrastructure. Information received by the analytical infrastructure from patients, prescribers, IDNs, payers and pharmaceutical companies can be used to derive a unified commercial strategy that specifies budget allocations for commercial resources such as marketing, managed markets and sales. Data received from the patient may include information provided by the patient to the patient's healthcare provider. For example, the information may include demographic information (gender, location, job title etc.). The data about the patient received from the prescriber may be sanitized patient data, therefore the patient's identity remains anonymous. Patient data may also include information about the patient's insurance company. The information may include the name of the patient's insurance company, the type of coverage the patient may have. Information about a patient may also be received from the retail pharmacy that fulfills a prescription for the patient.

The data received from the prescriber may include a prescriber identifier and a network identifier. The prescribe identifier may be an identifier associated with a physician or nurse practitioner writing a prescription. The network identify may identify the IDN that the prescriber may be a member. Prescriber information may also include information on the prescriber's prescription history. This information may include the total number of prescriptions written by the prescriber, and the number of prescriptions written for a particular drug. The prescriber information may be received from prescribers within a specific geographic location.

The information received from an IDN may include prescription information from the physicians within the network. The IDN may also provide information about the patients treated within the network. The information may include sanitized patient information, so that the patient remains anonymous, the condition the patient is treated for, and the pharmaceutical drug prescriptions provided to the patient by health care providers within the network. The IDN may also provide patient payment information. This information may include the type of payment the patient used to cover the received health care services. For example the information may include if the patient paid by cash, if the patient used insurance and paid co-pay or if the user was covered by Medicaid.

A payer may be the insurance company that covers the patient, or in the case where the patient does not have insurance, the payer may be the government, where the patient is covered by Medicaid. The payer may in some cases be the patient, where the patient purchases prescription drugs without insurance coverage. Information received from the insurance companies may include the names of the pharmaceutical products covered by the company. The information may include information about prescription drugs which are used to treat popular conditions and the prescription drug that is covered by the insurance company. For example, the information may include Lipitor as the pharmaceutical drug covered by the insurance company for the treatment of cardiovascular disease. The payers information may include information received from insurance companies within a specific geographic location.

The information from the pharmaceutical company may include the marketing sales information for the marketing of a specific pharmaceutical product. For example, the information may include the total number of free samples of a Lipitor that were distributed to physicians. The information may also include information on the revenue spent on the marketing of a particular product, the total number of sales of the product, the revenue spent on door to door sales of the product etc. The information may further include the specific prescribers within an IDN that received free samples or coupons for a product. The pharmaceutical marketing tactics information may include marketing information of a specific product in a specific geographic.

The computing systems of the analytical infrastructure accesses the information received from all the stakeholders that may have an influence on the selected treatment choice. The analytical infrastructure may use the information to calculate an influence factor for the treatment choice influences. In some implementations, the analytical infrastructure may weigh each of the individual elements ratings associated with the information received from patients, prescribers, groups (IDNs), payers and pharmaceutical companies, and apply an equation to calculate an influence factor for each element. The influence factor calculated by the statistical analysis module may be used by the analytical infrastructure to determine the influence of patients, prescribers, groups (IDNs), payers and pharmaceutical companies to treatment choice. In some implementations, the analytical infrastructure module may use one or more statistical models to quantify the influence patients, prescribers, groups (IDNs), payers and pharmaceutical companies on treatment choice.

The analytical infrastructure may use the information and the calculated influence factors to determine the relative influence of the patient, prescriber, groups (IDNs), payers and pharmaceutical company. The analytical infrastructure may use the marketing, sales and payer data of a product provided by the pharmaceutical company to calculate a performance indicator. In some implementations, the analytical infrastructure may use one or more statistical models to generate a performance indicator for a commercial strategy based on the sales of the pharmaceutical product. For example, door to door sales of a product may receive a high performance indicator if the physicians that were visited in the door to door visits prescribed the product and contributed considerably to the sales revenue of the product.

The analytical infrastructure generates a unified commercial strategy report based on the marketing sales data and the calculated performance indicator of marketing strategies. In some implementations, the analytical infrastructure may generate a unified commercial strategy for a pharmaceutical company based on one pharmaceutical product in a specific geographical location. In other implementations, the unified commercial strategy is based on a nationwide location. The analytical infrastructure has the ability of identifying if allocating funds for the promotion of a particular pharmaceutical product is supported by the IDNs within the area. For example, the analytical infrastructure may, based on a selected geographical location determine the marketshare of one more IDNs within a geographic location and evaluate the total revenue spent in promoting the pharmaceutical product in the area and compare the data to determine if the budget allocated to the geographical location is justified, that is if the revenue spent leads to profitable returns.

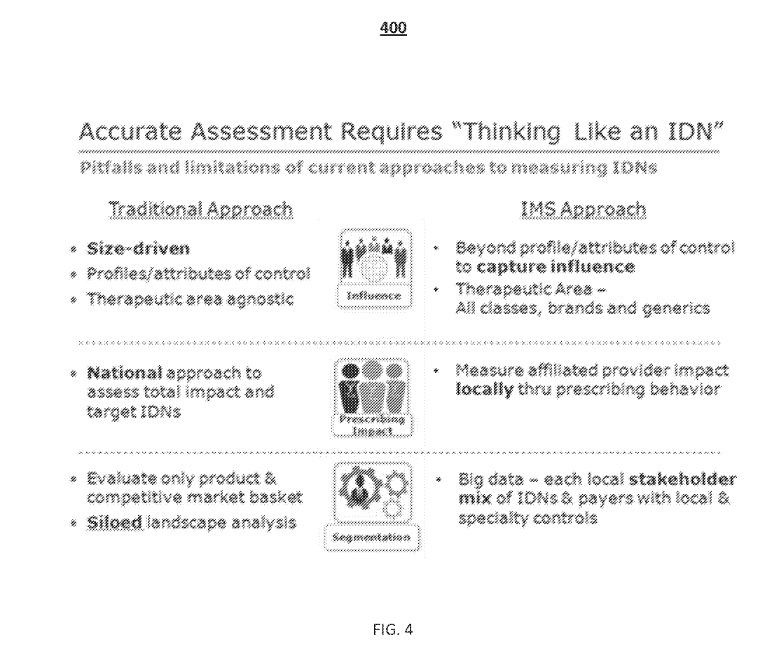

FIG. 4 illustrates a comparison between two market assessment methodologies. The figure describes the differences of the traditional approach of measuring the impact of IDNs on a pharmaceutical market to the inventive approach described within. The traditional approach for measuring the impact of IDNs includes several pitfalls and limitations. Firstly, traditional approaches to measure the influence of a particular IDN on a pharmaceutical market are merely driven by size. In the past, pharmaceutical manufacturers have valued the influence of provider networks based on the size of the network. The influence of an IDN is usually projected as being proportional to the size of the IDN, that is the larger the size of an IDN the greater the influence of the IDN on the market. Traditional approaches to IDN impact may be therapeutic area agnostic, and do not analyze each specific therapeutic area to determine a more realistic estimate of IDN influence. Secondly, traditional approaches to determining the prescribing impact of physicians use a national approach to assess total impact and to target IDNs. Data is collected on a national level to assess the size of an IDN and to estimate the influence of an IDN nationally. Thirdly, traditional approaches evaluate only product and competitive market baskets. Pharmaceutical manufacturers use these projections to develop marketing strategies for pharmaceutical products, and may sometimes yield unreliable results using these traditional IDN influence assessment methods. Therefore there is a need for an approach to measure IDN impact that is accurate and does not suffer from the identified limitations of these traditional approaches.

The inventive approach for measuring the impact of an IDN utilizes both quantitative and qualitative measures to assess IDN impact. The IDN impact is aligned by a particular disease state, a regional location, and the individual characteristics of the IDN. Unlike traditional approaches, the inventive approach is not merely a size driven approach but goes beyond profile attributes of control to capture IDN influence. The inventive approach uses quick and efficient computing to access and analyze large data sources. The analysis of the large data sources are performed at high speeds. The computer resources are an essential component of this inventive process, and without the computing systems, analyzing the large amount of data would be impossible. The computing systems have the ability to identify and analyze data associated with a particular therapeutic area. The computing systems analyze all classes, brands, and generics of pharmaceutical products used to treat a particular therapeutic area. The inventive methodology involves measuring local impact of providers associated with an IDN through the prescribing behavior of providers. In more detail, the computing systems access and analyze data that is specific to a particular regional geographic area for a disease state of interest. The prescribing behavior of physicians within an IDN is impacted by IDN affiliations, and the impact of an IDN affiliation in one region may be different that the impact in a different region for any particular disease state. For example, Kaiser Permanente may impact physicians in New York City differently that it may impact physicians in Washington D.C. for the treatment of high blood pressure. These differences in impact on physicians for prescribing pharmaceuticals for high blood pressure may be due to different reasons. The computing systems may access the data for each geographical region, and may measure the IDN impact in particular regions.

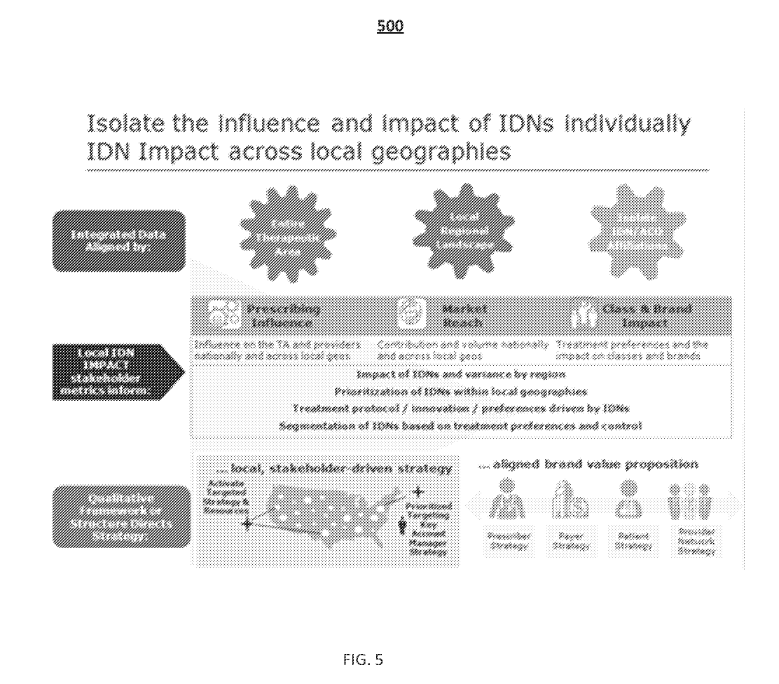

FIG. 5 illustrates the impact of Integrated Delivery Networks (IDNs) across local geographies. The computing systems at the analytical infrastructure use integrated data that is aligned by therapeutic area, local regional landscape, and provider network (IDN/ACO) affiliations. The computing systems at the analytical infrastructure may execute various mathematical equations, algorithms, and other computations on the received data. The quantitative and qualitative aspects of the data used to measure the impact of IDNs in a local region may be classified by prescribing influences, market reach, and class and brand impact. The prescribing influence measures the influence on the providers nationally and across local geographic regions. The market reach measures the contribution and volume nationally and across local geographic regions, and the class and brand impact measures the treatment preferences and the impact on classes and brands. These qualitative and quantities metrics derived from the data received at the analytical infrastructure is used to estimate the impact of one or more IDNs within a geographic region of interest, and the variance by geographic region. The estimated impact of the one or more IDNs in a particular geographic region is then used to generate a prioritized list of the IDNs within the region that should be targeted when marketing a pharmaceutical product that is used for the therapeutic area. The computing systems at the analytical infrastructure may field and/or mine the received data to determine the treatment protocols and other preferences of the one or more IDNs in a geographical region. The computing systems may then segment the IDNs based on the treatment preferences. The derived analytics may be used to develop a robust marketing strategy for the specified target area.

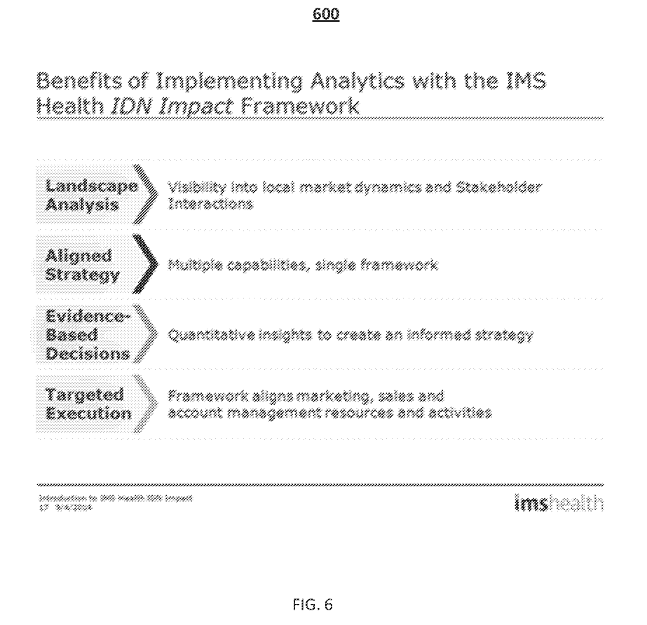

FIG. 6 illustrates the benefits of the analytical infrastructure in determining the impact of IDNs. The advantages of implementing the inventive approach to estimate the impact of an IDN in a geographical region include the ability of pharmaceutical manufactures that utilize the data garnered from this approach to understand thoroughly the market analysis of the landscape. The methodology allows for a high visibility into market dynamics on a very local scale. Traditionally IDN impacts have been measured on a national approach, and have failed to provide insight into the local market dynamics. The methodology also allows for an understanding of stakeholder interaction on a local stage. For example, the dynamics between payers, prescribers, and IDN within a zip code may be analyzed and understood for a therapeutic area of interest.

The methodology implemented by the computing systems of the analytical infrastructure includes the capability of enabling pharmaceutical manufacturers to assess the impact of one or more IDNs in a geographic location within all classes of a therapeutic area. A single framework can assess impact, and generate a rank list that prioritizes the assessed IDNs. The same framework is used to develop regionally relevant commercial marketing strategies for pharmaceutical products. The quantitative data used by the computing systems at the analytical infrastructure allows pharmaceutical manufacturers to develop an informed market strategy. The computing systems at the analytical infrastructure align marketing data, sales data, and account management resources data to enable a targeted execution of marketing strategies.

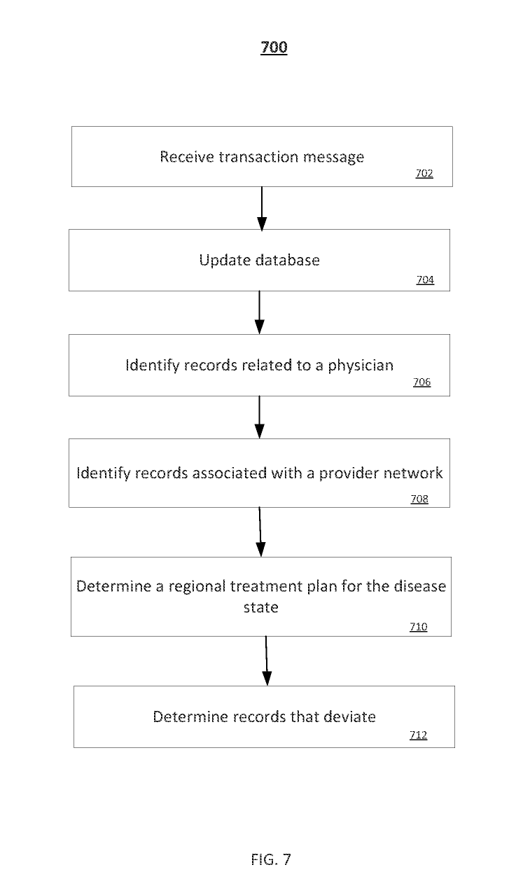

FIG. 7 is a flow chart of the process for identifying records that deviate from a preferred prescribed course of care for a particular disease state. The computing systems at the analytical infrastructure receive a transaction message including data related to a disease state (702). The transaction message received may be a data file, a stream of data, or a datagram. The transaction message includes one or more datasets from one or more computing systems. The computing systems at the analytical infrastructure are in electronic communication with one or more provider network systems, one or more patient systems, one or more prescriber systems, one or more pharmaceutical distributor systems, and one or more payer systems. The computing systems at the analytical infrastructure receives large datasets that include prescriptions written by physicians within provider networks from the one or more provider network systems. The prescription data received represents over 70% of the prescriptions written by physicians in a specific geographical area over the past 30 years. The datasets are updated weekly with the past weeks prescription data. The computing systems at the analytical infrastructure are in electronic communication with one or more patient systems. The computing systems at the analytical infrastructure receive large datasets that represent longitudinal patient level data. The longitudinal patient level data comprises sanitized patient level data that includes treatment details and prescription history of a large percentage of the patient population of the specific geographical area. The longitudinal patient level data represents patient data over the past 70 years. The computing systems at the analytical infrastructure are also in electronic communication with one or more prescriber systems. The datasets received from the prescriber systems include prescriber details for over 90% of the prescriber population of the specific geographical region. The prescriber details includes the prescriber specialty, demographic information, and provider network or IDN affiliations. The computing systems at the analytical infrastructure receive pharmaceutical wholesale purchase data from one or more pharmaceutical distributor systems. The data includes close to 100% of the manufacturer purchase data for the specific geographic area for the past 50-60 years. The computing systems at the analytical infrastructure receive insurance claims data from one or more payer systems. The insurance claims data represents over 60% of the claims data for the specific geographical area for the past 40 years. The computing systems at the analytical infrastructure receive these datasets on a periodic basis from the one or more computer systems. The transaction message received at the computing system of the analytical infrastructure may include treatment algorithms for the disease state, and may include information from associations dedicated to the treatment of the particular disease state. The received data is data for a particular geographic region of interest. For example, the received data may represent prescription data, longitudinal patient data, prescriber data, pharmaceutical purchase data, and insurance data for a particular state, county, or zipcode.

The computing systems at the analytical infrastructure update a database based on the received transaction message (704). The datasets received as the transaction message at the computing systems of the analytical infrastructure are integrated, and the integrated data sources are stored at the updated database. The updated database may be a computational database. The updated database may have the processing capability to execute extensive computations and calculations. The computing systems at the analytical infrastructure are adapted to process the received datasets in a way that facilitates efficient operation for computational tasks. The processing operations of the computing systems are both time and energy efficient. The received data is organized and stored as one or more data structures. The one or more data structures are designed so the received data can be stored, accessed, and processed efficiently. The one or more data structures are specially formatted for the organization and storage of the received data. The one or more data structures are designed to store the received data for the purpose of working on the received data with one or more algorithms. The one or more data structures at the updated database may be one or more arrays, one or more records, one or more associative arrays, one or more objects, and/or one or more trees. In some examples, the one or more data structures may be one or more other data structure types.

The computing systems at the analytical infrastructure identify records related to a physician within the updated database (706). The computing systems may execute one or more computing cycles to identify prescriptions written by physician, patients that have been treated by the physician, provider networks that the physician is affiliated with, insurance claims associated with prescriptions written by the physician, the prescriber data associated with the physician, and other data associated with the physician within the integrated datasets. In some examples, the computing systems may field/and or mine the integrated datasets for data records associated with the physician name, or a physician identifier associated with the physician. The computing systems at the analytical infrastructure may generate one or more references to records identified as being related to a physician. The one or more generated references may be stored at a computational database. The generated references are used as tags for the identified records. The generated references may be an identifier, such as a physician code, for example, a binary code that represents a part of the data referenced. For example, the generated reference may tag the record with the name of the physician and the disease state treated within the data record. The computing systems at the analytical infrastructure receive large amounts of data on a periodical basis. The one or more data structures that store the received data are designed to facilitate the real time processing of the periodically received data. The computing systems receive the data and identify the records related to a particular physician. The related records are tagged with unique physician code and are stored at a computational database. In some examples, the records associated with the particular physician are stored in one data structure, such as a table.

The computing systems at the analytical infrastructure identify records associated with a provider network based on the records related to the physician (708). The computing systems may execute one or more computing cycles to identify within the records related to the subject physician, records that are associated with a provider network. The records may represent patient treatment events for patients that have been treated by the physician within the provider network, the insurance claims covered by the provider network, the prescriptions covered by the provider network, the physician provider network affiliation associated with prescriber data, and other data associated with the physician and the provider network within the integrated datasets. In some examples, the computing systems may field and/or mine the integrated datasets for data records associated with a provider network identifier. The computing systems at the analytical infrastructure may generate one or more references to records identified as being related to the provider network. The one or more generated references may be stored at a computational database. The generated references are used tags for the identified records. The generated references may be an identifier, or in some examples, binary code that represents a part of the data referenced. For example, the generated reference may tag the record with the name of the physician and the disease state treated within the data record. The computing systems at the analytical infrastructure receive large amounts of data on a periodical basis. The one or more data structures that store the received data are designed to facilitate the real time processing of the periodically received data. The computing systems receive the data and identify the records related to a particular provider network. The related records are tagged with a unique provider network code and are stored at a computational database. In some examples, the records associated with the particular provider network are stored as a table, or any other suitable data structure.

The computing systems determine a first treatment plan for the disease state based on the records related to the physician (710). The computing systems may use one or more algorithmic computations to determine the one or more trends in the prescribing behavior of the specific physician for the disease state. For example, the computing systems may determine based on the records identified as being associated with Dr. Doe, that his treatment plan for diabetes includes prescribing 40 mg of Januvia. In some examples, the determined treatment plan includes estimations of the volume of the prescribed product, the recommended dosage of the product, the length of the treatment period, and any other suitable details of a treatment plan. The computing systems access the records stored in the database associated with the unique physician code. The related records may be stored at a table. The computing systems may process the related records to quickly and efficiently determine a similarity in the prescribing transactions associated with the records assigned with the physician code. In some examples, the computing systems access the complete data table or database with the related records of prescription transactions to determine a treatment plan for the specific physician. In some other examples, the computing systems access the records associated with data that has been received in the latest periodic data cycle. This allows the computing systems to determine the treatment plan based on the current prescribing tendencies of the physician. In the event that the computing systems have not identified records related to the physician for the particular disease state in the latest received data, the computing systems may determine the first treatment plan for the disease state based on the data received before the given period. The regional treatment plan may represent the prescribing tendencies of a physician that is not associated with a provider network. The regional treatment plan may be determined for a specific county, state, zip code, or any other suitable region. In some implementations, the regional treatment plan may be a treatment plan developed by and/or endorsed by industry associations such as American Diabetes Association (ADA) and other similar associations.

The computing systems at the analytical infrastructure generate an impact record based on the first treatment plan for the disease state and the records associated with the provider network (712). The computing systems assess an impact of the provider network based on the identified records related to the physician, and the records associated with the provider network. The computing systems at the analytical infrastructure use one or more quantitative metrics to measure the provider network influence on the physician prescribing behavior for the particular disease state across local geographies. The one or more metrics uses by the computing systems analyze the treatment preferences of the physician, and the impact of the preferences across classes of drugs within the disease state and across brands of drugs within the disease state. The computing systems measures the provider network impact, and determine the influence of the provider network impact on the physicians' prescribing behavior. The computing systems at the analytical infrastructure use both quantitative and qualitative measures to determine the impact record. The determined impact record is aligned by the particular disease state, the regional location, and the individual characteristics of the physicians within the provider network. The computing systems at the analytical infrastructure have the ability to generate the impact record in real time. The computing systems update the impact record on a periodic basis as new data is received at the analytical infrastructure. The impact record generated may include an impact attribute. The impact attribute may be one of a group of attributes for a particular provider network. In some examples, the impact attribute may be stored as a record. In some other examples, the impact attribute may be stored as a value in a table data structure.

The computing systems at the analytical infrastructure identify records that deviate from the preferred prescribed course of care based on the impact record (714). The computing systems can determine the records associated with the physician that are impacted by the provider network. For example, the physician may treat patients at a free clinic, the physicians' provider network affiliations may not affect the prescribing behavior of the physician for patients at the free client. The computing systems can identify records within the prescribers' record that deviate from a preferred course of care. The preferred course of care may include estimations of the volume of the prescribed product, the recommended dosage of the product, the length of the treatment period, and any other suitable details of a treatment plan. The computing systems use a mathematical model to identify records that deviate from the preferred course of care. The computing systems have the processing ability to determine the records that deviate from the preferred prescribed course of care in real time. The computing systems at the analytical infrastructure process the one or more generated references to identified records related to the physician and the one or more generated references associated with the provider network to facilitate increased processing speeds. The computing systems can process the relevant data records by processing only the data associated with the generated references instead of processing all the data at the updated database. This pre-processing of the datasets to generate the references significantly decrease the processing time for determining the records that deviate from the preferred prescribed course of care.

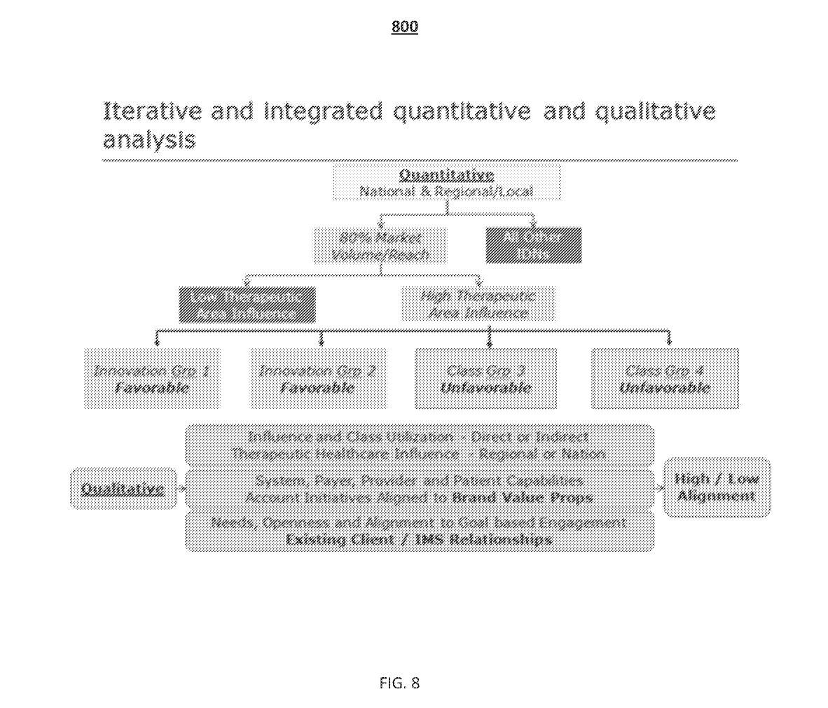

FIG. 8 illustrates the quantitative and qualitative analysis used by the analytical infrastructure. The computing systems at the analytical infrastructure may execute various mathematical equations and other computations on the received data. The computing systems at the analytical infrastructure are in electronic communication with one or more provider network systems. The analytical infrastructure receives large datasets including prescriptions prescribed by physicians within the provider networks. The prescription data received represents over 70% of the prescriptions written by physicians in a specific geographical area over the past 30 years. The datasets are updated weekly with the past weeks prescription data. The computing systems at the analytical infrastructure are in electronic communication with one or more patient systems. The computing systems at the analytical infrastructure receive large datasets that represents longitudinal patient level data. The longitudinal patient level data comprises sanitized patient level data that includes treatment details and prescription history of a large percentage of the patient population of the specific geographical area. The longitudinal patient level data represents patient data over the past 70 years. The computing systems at the analytical infrastructure are also in electronic communication with one or more prescriber systems. The datasets received from the prescriber systems includes prescriber details for over 90% of the prescriber population of the specific geographical region. The prescriber details includes the prescriber specialty, demographic information, and provider network or IDN affiliations. The computing systems at the analytical infrastructure receive pharmaceutical wholesale purchase data from one or more pharmaceutical distributor systems. The data includes close to 100% of the manufacturer purchase data for the specific geographic area for the past 50-60 years. The computing systems at the analytical infrastructure receive insurance claims data from one or more payer systems. The insurance claims data represents over 60% of the claims data for the specific geographical area for the past 40 years. The computing systems at the analytical infrastructure receive these datasets on a periodic basis from the one or more computer systems. The quantitative data received at the computing systems represents the data from one or more regional geographic locations for a particular disease state of interest. The data from the one or more different geographical regions together represent the provider networks on a national scale. The quantitative data represents over 900 IDNs and/or provider networks in the United States of America.

The computing systems at the analytical infrastructure assess the impact of the IDNs in the one or more geographical areas. The computing systems at the analytical infrastructure use one or more quantitative metrics to measure the provider network influence on the physician prescribing behavior for the particular disease state across local geographies. The one or more metrics uses by the computing systems analyze the treatment preferences of the physician and the impact of the preferences across the one or more classes of drugs within the disease state and across brands of drugs within the disease state. The computing systems at the analytical infrastructure identify the IDNs that represent approximately 80 percent of the market volume for a particular disease state. The computing systems at the analytical infrastructure may use one or more algorithmic computations to generate a provider network impact score for the one or more provider networks in a specific geographic region. The provider network score reflects the impact the network exerts on the prescribing behavior of one or more physicians within the localized region. The provider networks with the highest impact scores are identified by the computing systems.

The computing systems at the analytical infrastructure determine which IDNs have a therapeutic area influence that is above a threshold therapeutic influence. For example, the computing systems may identify the provider networks with an impact score that is higher than seventy five percent. IDNs that are determined by the computing systems at the analytical infrastructure to have a therapeutic influence that is below the threshold are excluded from the dataset for further processing. The therapeutic area threshold may be a threshold set by an authorized user at the analytical infrastructure. The market volume and the therapeutic area influence are metrics are collectively described as impact metrics. These impact metrics are used by the analytical infrastructure to eliminate IDNs that should not be targeted by pharmaceutical companies that are developing marketing strategies for a particular geographic location for a particular pharmaceutical product. The computing systems at the analytical infrastructure further categorize the IDNs with a high therapeutic area influence into a favorable and none favorable group. For example, the analytical infrastructure may identify 20-25 IDNs as favorable to the marketing of pharmaceutical products in the high blood pressure therapeutic area. This process of elimination of IDNs that either represent a market volume less than 80%, and/or does not exert a high influence in the therapeutic area of interest allows pharmaceutical companies to focus their marketing and sales tactics to physicians that are influenced by the identified IDNs as exhibiting favorable conditions. The computing systems at the analytical infrastructure determine an IDN impact score for each of the favorable IDNs, and ranks the IDNs based on the score. The IDNs that are ranked highly by the computing systems indicate to the pharmaceutical companies the IDNs that should be targeted by various marketing and sales tactics. Pharmaceutical companies that are interested in introducing a new product onto the market may use the IDN rankings to determine which physicians should be targeted by a sales force. The methodology may also be used to market an existing pharmaceutical product in a new or existing market. The methodology described incorporates the regional IDN impact score into a region's market potential.

The methodology allows for the sizing and structuring of a sales force within a geographical region. The computing systems at the analytical infrastructure determine field sale plans, marketing goals, and marketing plans for each of the one or more IDNs that are identified as favorable for a specific disease state in a specific geographic region. The computing systems at the analytical infrastructure assess the potential market size of a specific geographic area based on the determined IDN impact score. The IDN impact score allows the computing systems to account for the impact of one or more IDNs in a particular geographic region, and facilitates the generating of sales force structures and sizing attributes based on the IDN impact score.

The computing systems generates a marketing strategy based on the assessed IDN impact score of the one or more provider networks in a specific geography. The market strategy prioritizes the one or more provider networks based on one or more factors. The market strategy factors in the one or more classes of drugs for a particular disease state. The computing systems at the analytical infrastructure determine whether a specific drug belongs to a class of drugs favored by a provider network. The computing systems generate a go to market strategy that may include promotional mix modeling, resource optimization, sales force structure and sizing, and promotional content strategy.

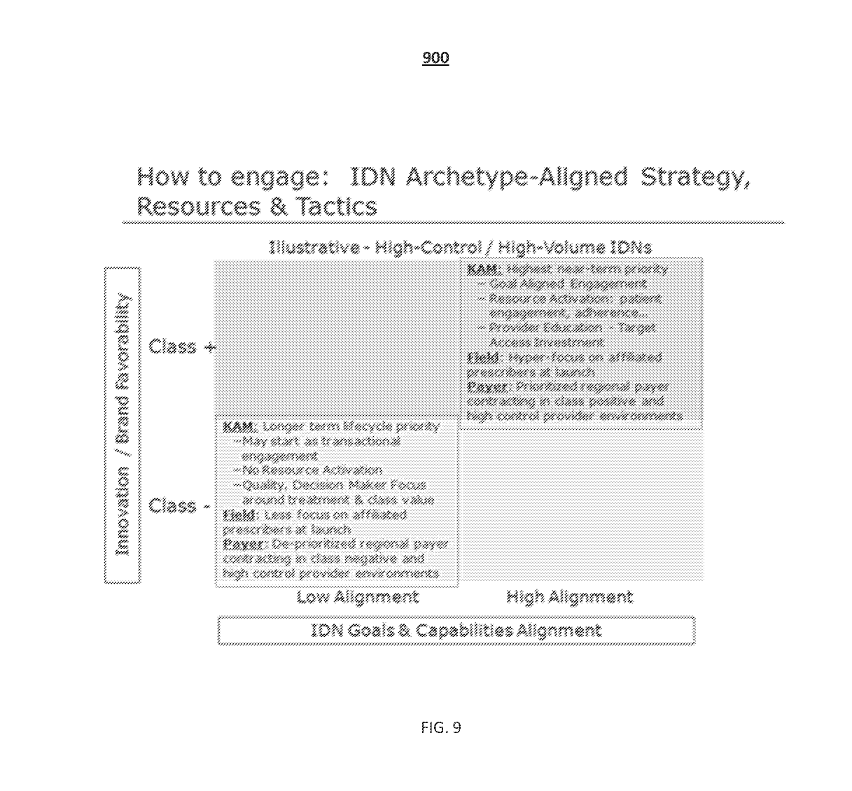

FIG. 9 illustrates an example strategy for determining a favorable IDN versus an unfavorable IDN by the analytical infrastructure. The methodology allows a pharmaceutical company to measure the brand favorability by class of drug alongside the IDN goals and capability alignment. As illustrated in FIG. 9, a high alignment with the IDN goals with brand favorability would be characterized by hyper-focus on affiliated prescriber at the time of launch, prioritized regional payer contracting in class positive and high control provider environment. The resource activation includes patient engagement and adherence. On the other hand a low alignment with IDN goals and capabilities may be characterized by long term lifecycle priority, no resource activation, less focus on affiliated prescribers at launch and de-prioritized regional payer contracting in class negative and high control provider environments.

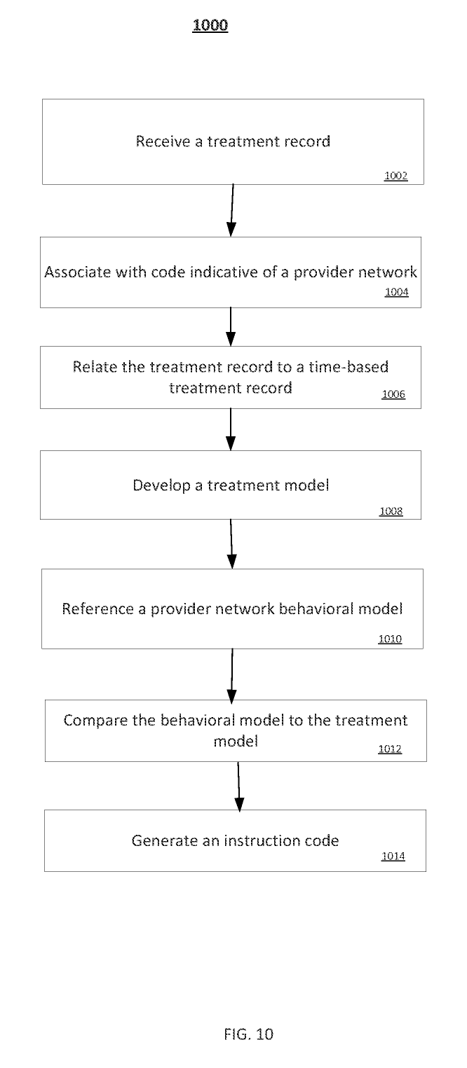

FIG. 10 is a flow chart of a process by which an analytical infrastructure generates an instruction record. The computing systems at the analytical infrastructure receive a treatment record descriptive of a pharmacy purchase transaction that includes a prescriber identification code and a pharmaceutical compound related to the treatment for an individual disease state (1002). The treatment record may include the volume of the pharmaceutical compound, the recommended dosage of the compound, one or more indications of the compound, the recommended treatment period, and any other suitable details of a pharmacy purchase transaction record. The treatment record may be received by the computing systems at the analytical infrastructure from the computing systems of one or more computing systems. The computing systems at the analytical infrastructure may be in electronic communication with the computing systems of one or more systems, and receive datasets that include prescriber details for over 90% of the prescriber population of the specific geographical region. The prescriber details includes the prescriber specialty, demographic information, and provider network or IDN affiliations. The treatment record relates the pharmaceutical product to a particular disease state. For example, the pharmaceutical product may be related to the diabetes disease state. The recommended pharmaceutical product used for the treatment of the disease state may be a new pharmaceutical product for sale by a pharmaceutical product. In some examples, the recommended pharmaceutical product may be a product with a new indication for the particular disease state. In other examples, the recommended pharmaceutical product may be a product that has been traditionally used for the treatment of the particular disease state.

The computing systems at the analytical infrastructure associate the received treatment record with a code indicative of a provider network (1004). The computing systems may append the treatment record with a reference code or a particular provider network and/or IDN of interest. The treatment record with the appended reference code may be stored as a data structure at a computational database at the analytical infrastructure. The data structure is designed to allow efficient access and efficient process of data within the data structure. In some examples, the treatment record with the appended reference code may be stored as one or more data structures. The computing systems at the analytical infrastructure relate the treatment record to a time-based treatment record descriptive of a projected disease state for a specified treatment area (1006). The time-based treatment record may be a record generated by the computing systems at the analytical infrastructure. In some implementations, the treatment record may be a data record generated by an external third party, and that is electronically communicated to the computing systems at the analytical infrastructure. The computing systems receive data from one or more provider network systems, one or more prescriber systems, one or more payer systems, one or more patient systems, and one or more pharmaceutical distributor systems on a periodic basis. The computing systems may process the received data to project a market size for a particular disease state within a particular treatment area. The market size projection for the particular treatment area is used to generate the treatment record. The time-based treatment record may be updated on a weekly basis as the computing systems at the analytical infrastructure receives data. The treatment record is time-based and reflects the most current market landscape.

The computing systems at the analytical infrastructure develop a treatment model that indicates projected occurrences of the disease state over a specified time frame based on relating the received treatment record to the time based treatment record (1008). The developed treatment model may be based on the projected market size for the disease state. The developed treatment model is based on a particular disease state in a particular localized geographic region. For example, the treatment model may be developed for New York City for the kidney disease disease state. The projected occurrences including a first code indicative of a prescribing authority, the treatment model also including an association label that identifies a linkage between treatment records with a threshold degree of similarity. The computing systems at the analytical infrastructure may generate the treatment model and may tag data records that represent a degree of similarity with a similarity code.

The computing systems at the analytical infrastructure reference a provider network behavioral model for the provider network based in the code indicative of the provider network (1010). The provider network behavioral model is a model that measures the impact of an IDN on a geographical location for a particular therapeutic area or disease state. The model measures the impact of a provider network and/or IDN utilizing both quantitative and qualitative measures to assess IDN impact. The provider network model aligns the IDN impact by a particular disease state, a regional location, and the individual characteristics of the IDN.

The computing systems at the analytical infrastructure use the code indicative of the provider network to update the provider network behavioral model (1012). In some examples, the provider network behavioral model may be updated on a periodic basis. For example, the computing systems at the analytical infrastructure receive data on a periodic basis, and update the provider network behavioral model based on the received data. The computing systems at the analytical infrastructure compare the updated provider network behavioral model to the treatment model (1014). The computing systems at the analytical infrastructure use one or more algorithms to compare the updated provider network behavioral model to the developed treatment model to determine how the provider network impact would correlate to the developed treatment model. In some implementations, the computing systems may determine that based on the impact of a particular provider network, the treatment model would not be sustained in a specific geographic area.

The computing systems at the analytical infrastructure generate an instruction record for the specified treatment area based on comparing the updated provider network model to the treatment model (1016). The instruction record is a record indicative of a go to market strategy for the particular pharmaceutical compound. The instruction record is generated by the computing systems and may be stored as a data structure. The data in the instruction record is indication of a go to market strategy that assesses the impact of one or more provider networks on a local region, and aligns the market strategy to obtain the best market value for the pharmaceutical product. The computing systems at the analytical infrastructure identify the treatment behavior of physicians within the geographic region that are affiliated with a provider network, and compare and contrast their treatment behavior to the treatment behavior of physicians within the same geographic region that are not affiliated with a provider network.

The generated instruction record that is indicative of a go to market strategy prioritizes the one or more provider networks in a given geographic region based on several different factors. The computing systems at the analytical infrastructure determine whether the particular pharmaceutical product falls within the class of drugs favored by a particular provider network, and determine whether the provider network has a high impact score for the particular disease state treated by the pharmaceutical product in the specific geographic region. The computing systems at the analytical infrastructure also assess whether the pharmaceutical product is a new drug in the launch stage, or whether the drug is further along its life cycle. The instruction record incorporates these and other factors. The instruction record indication of the go to market strategy for the pharmaceutical product may include promotional mix modelling, resource optimization, sales force structure and sizing, and promotional content strategy.

The generated instruction record may include an aggregated impact label indicative of addressable disease states for a specified treatment area. The generated instruction record may be stored as a data structure. The data structure represents the go to market strategy for the specific geographic area for the particular disease state. The generated instruction record may be generated in the time required to establish a transmission control protocol connection.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network, for example, shared or private computing clouds. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

Pharmaceuticals in various implementations need not necessarily be heavily controlled, and the methods presented herein equally apply to over-the-counter drugs or even potentially to herbal preparations or nutritional supplements that have the potential to have an impact on medical treatment. The use of St. John's Wort to treat a patient with clinical depression may be considered by an implementation, as may a nutritional supplement such as fish oil or a prescription antidepressant.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A computer-implemented method comprising:
receiving a treatment record descriptive of a pharmacy purchase transaction that includes a prescriber identification code and a pharmaceutical compound related to the treatment for an individual disease state;
associating the received treatment record with a code indicative of a provider network;
relating the treatment record to a time-based treatment record descriptive of a projected disease state for a specified treatment area;
developing, based on relating the received treatment record to the time-based treatment record, a treatment model that indicates projected occurrences of the disease state over a specified time frame, the projected occurrences including a first code indicative of a prescribing authority, the treatment model also including an association label that identifies a linkage between treatment records with a threshold degree of similarity;
referencing a provider network behavioral model for the provider network based on the code indicative of the provider network;
using the code indicative of the provider network to update the provider network behavioral model;
comparing the updated provider network behavioral model to the treatment model; and
generating, based on comparing the updated provider network behavioral model to the treatment model, an instruction record for the specified treatment area, wherein generating the instruction record comprises generating an aggregated impact label indicative of addressable disease states for a specified treatment area.

2. The method of claim 1 wherein generating an instruction record for the specified treatment area based on comparing the provider network behavioral model to the treatment model comprises generating an instruction record for the specified treatment area in the time required to establish a Transmission Control Protocol (TCP) connection.

3. The method of claim 1 wherein developing a treatment model based on relating the received treatment record to the time-based treatment record comprises developing a treatment model of local prescribers non-affiliated with a provider network.

4. The method of claim 1 wherein referencing a record descriptive of a provider network comprises referencing a record that includes a provider network impact score.

5. The method of claim 4 wherein the provider network impact score assesses the impact of the provider network on the prescribing behavior within the specified treatment area.

6. The method of claim 4 wherein the provider network impact score assess the impact of the provider network on the prescribing behavior of physicians on a national level for the particular disease state.

7. The method of claim 4 wherein the provider network impact score evaluates the prescribing behavior of physicians within one or more classes of drugs used to treat the disease state.

8. The method of claim 1 wherein referencing a time-based treatment model descriptive of a projected disease state for a specified treatment area comprises associating qualitative and quantitative pharmaceutical data to model an instruction model.

9. The method of claim 1 wherein referencing a time-based treatment model descriptive of a projected disease state for a specified treatment area comprises referencing a time-based mathematical model descriptive of a projected disease state for a particular a state, county, or zip code.

10. A system comprising:
one or more computers and one or more storage devices storing instructions that are operable, when executed by one or more computers, to cause the one or more computers to perform operations comprising:
receiving a treatment record descriptive of a pharmacy purchase transaction that includes a prescriber identification code and a pharmaceutical compound related to treatment for an individual disease state;
associating the received treatment record with a code indicative of a provider network;
relating the treatment record to a time-based treatment record descriptive of a projected disease state for a specified treatment area;
developing, based on relating the received treatment record to the time-based treatment record, a treatment model that indicates projected occurrences of the disease state over a specified time frame, the projected occurrences including a first code indicative of a prescribing authority, the treatment model also including an association label that identifies a linkage between treatment records with a threshold degree of similarity;
referencing a provider network behavioral model for the provider network based on the code indicative of the provider network;
using the code indicative of the provider network to update the provider network behavioral model;
comparing the updated provider network behavioral model to the treatment model; and
generating, based on comparing the updated provider network behavioral model to the treatment model, an instruction record for the specified treatment area, wherein generating the instruction record comprises generating an aggregated impact label indicative of addressable disease states for a specified treatment area.

11. The system of claim 10 wherein generating an instruction record for the specified treatment area based on comparing the provider network behavioral model to the treatment model comprises generating an instruction record for the specified treatment area in the time required to establish a Transmission Control Protocol (TCP) connection.

12. The system of claim 10 wherein developing a treatment model based on relating the received treatment record to the time-based treatment record comprises developing a treatment model of local prescribers non-affiliated with a provider network.

13. The system of claim 10 wherein referencing a record descriptive of a provider network comprises referencing a record that includes a provider network impact score.

14. The system of claim 13 wherein the provider network impact score assesses the impact of the provider network on the prescribing behavior within the specified treatment area.

15. The system of claim 13 wherein the provider network impact score assess the impact of the provider network on the prescribing behavior of physicians on a national level for the particular disease state.

16. The system of claim 13 wherein the provider network impact score evaluates the prescribing behavior of physicians within one or more classes of drugs used to treat the disease state.

17. The system of claim 13 wherein referencing a time-based treatment model descriptive of a projected disease state for a specified treatment area comprises associating qualitative and quantitative pharmaceutical data to model an instruction model.

18. The system of claim 13 wherein referencing a time-based treatment model descriptive of a projected disease state for a specified treatment area comprises referencing a time-based mathematical model descriptive of a projected disease state for a particular a state, county, or zip code.

19. A non-transitory computer-readable medium storing software comprising instructions executable by one or more which, upon such execution, cause the one or more computers to perform operations comprising:
receiving a treatment record descriptive of a pharmacy purchase transaction that includes a prescriber identification code and a pharmaceutical compound related to treatment for an individual disease state;
associating the received treatment record with a code indicative of a provider network;
relating the treatment record to a time-based treatment record descriptive of a projected disease state for a specified treatment area;
developing, based on relating the received treatment record to the time-based treatment record, a treatment model that indicates projected occurrences of the disease state over a specified time frame, the projected occurrences including a first code indicative of a prescribing authority, the treatment model also including an association label that identifies a linkage between treatment records with a threshold degree of similarity;
referencing a provider network behavioral model for the provider network based on the code indicative of the provider network;
using the code indicative of the provider network to update the provider network behavioral model;
comparing the updated provider network behavioral model to the treatment model; and
generating, based on comparing the updated provider network behavioral model to the treatment model, an instruction record for the specified treatment area, wherein generating the instruction record comprises generating an aggregated impact label indicative of addressable disease states for a specified treatment area.
